(19) United States
(12) Patent Application Publication
(10) Pub. No.: US 2017/0081916 A1
(43) Pub. Date: Mar. 23, 2017

(54) Window Blind Control Apparatus

(71) Applicant: Louver-Lite Limited, Hyde (GB)

(72) Inventor: Andrew Greening, Sandbach (GB)

(21) Appl. No.: 15/126,121

(22) PCT Filed: Mar. 20, 2015
(86) PCT No.: PCT/EP2015/056026

§ 371 Date: Sep. 14, 2016

(30) Foreign Application Priority Data
Mar. 21, 2014 (GB) 1405125.4

(51) Int. Cl. E06B 9/72; E06B 9/42

(52) U.S. Cl. CPC E06B 9/72; E06B 9/42; E06B 2009/6809

(57) ABSTRACT

A window blind control apparatus including an electrically operated motor 4 having a stationary end 6 and a rotatable end 8; a stationary member to which the stationary end 6 of the motor 4 is secured; an operating switch 22; and a conduit 16, wherein one end of the conduit 16 carries the operating switch 22, the opposite end of the conduit 16 is coupled to the stationary member and electrical wires 26 which electrically connect the operating switch 22 to the motor 4 are located in use within the conduit 16.

The present invention relates to a window blind control apparatus and in particular to a roller blind control apparatus for use with motorised roller blinds.

Motorised window blinds tend to be controlled by an operating switch in the form of a wireless remote control or in the form of a switch fixed to a suitable substrate, such as a wall. Wireless remote controls offer certain benefits, such as the ability to control a window blind from a convenient location, but also have a number of drawbacks associated with them, including the ease with which a remote control unit can be misplaced or lost and that they are often dropped, which may result in the remote control unit ceasing to function and the window blind being inoperable until a replacement remote control unit has been obtained.

Similarly, operating switches which are fixed to a substrate may be difficult to reach, unsightly and/or require the electrical wires from the switch to the roller blind motor to be chased or recessed into the wall or other surface, or covered in some way to hide them from view.

In view of the above, it is desired to provide a motorised window blind that includes an operating switch connected to the blind is such a way that it is accessible, and is not required to be fixed to a substrate.

According to a first aspect of the invention, there is provided a window blind control apparatus including an electrically operated motor having a stationary end and a rotatable end; a stationary member which forms a part of the stationary end of the motor or which is secured to the stationary end of the motor; an operating switch; and a conduit, wherein one end of the conduit carries the operating switch, the opposite end of the conduit is coupled to the stationary member, and electrical wires which electrically connect the operating switch to the motor are located in use within the conduit.

Suitably, the conduit is fixed to the stationary member. Thus, in use, the conduit remains secured to the stationary member and is not detachable.

By securing the operating switch to the control apparatus via the conduit, the operating switch will not be misplaced, lost or damaged through being dropped. In addition, the use of the conduit to support the switch means that the switch does not need to be fixed to a substrate and the electrical wires connecting the switch to the motor are hidden within a hollow cavity defined within the conduit.

The window blind may be a roller blind. The term “roller blind” is intended to cover all blind systems based around a rotating tube. These include conventional roller blinds, but also include blinds such as pleated blinds, cellular blinds, Roman blinds and Venetian blinds that may be operated via a rotating tube.

In embodiments in which the window blind is a roller blind, the rotatable end of the motor may include one or more roller tube engagement elements adapted to engage a roller tube such that the roller tube is rotationally fixed to the rotatable end of the motor.

The stationary member may be any element or part of the blind control apparatus which is fixed in use and does not rotate. It may be a separate component that is provided to support the conduit or it may be a component for which support of the conduit is a secondary function. For example, its primary function may be to secure the stationary end of the motor to a mounting bracket. Suitably, the stationary member is a separate component that couples the stationary end of the motor to a mounting bracket wherein the component further functions to support the conduit. The use of a stationary member to couple the motor to a mounting bracket allows generic motors to be coupled to specific mounting brackets as appropriate.

The conduit suitably defines an enclosed channel therein, wherein the channel is only open at each end. Thus, the conduit may be a hollow tube which defines a longitudinal bore that is open at its opposite ends. The tube may have a cross section corresponding to any geometric shape. However, the tube suitably has a circular or rectangular cross section.

In an embodiment of the invention as defined anywhere herein, the tube is formed from a metal, such as and extruded aluminium tube, or from a polymeric material.

The conduit may be rigid, flexible or resiliently deformable, but is suitably flexible or resiliently deformable. In the context of the present invention, the term “flexible” refers to a tube which can be deflected out of a linear arrangement and which has little or no internal restorative forces in its deflected configuration to return the conduit to a linear configuration when the deflection force is removed. In practice, a flexible conduit will return to a linear configuration after deflection if it is suspended from the blind control apparatus. In this case, it is gravity that causes the conduit to return to a linear configuration.

The term “resiliently deformable” in the context of the present invention refers to a tube that may be deflected out of a rest configuration, but which returns to its rest configuration after the deflection force is removed as a result of internal restorative forces present in the conduit when in a deflected configuration. The rest configuration of a resiliently deformable conduit may or may not be a linear configuration.

The degree of flexibility or resilience will depend upon the physical characteristics of the material from which the conduit is formed.

In addition to, or as an alternative to, the conduit being flexible or resiliently deformable, the conduit may be hingedly coupled to the stationary member. In this embodiment, the hinge allows the conduit to pivot within a single plane, for example backwards and forwards or side to side. This allows the user to operate the switch from a convenient position.

Alternatively, the conduit may be coupled to the stationary member via a universal joint. Such an arrangement would allow the conduit to pivot in two orthogonal planes, for example forwards and backwards and side to side. This allows the switch to be operated from a greatly increased number of positions.

In an embodiment of the invention, the motor is a battery-powered motor and the window blind control apparatus further includes one or more batteries electrically connected to the motor in use. The batteries are suitably rechargeable batteries. Battery-operated motors do not require the motor to be electrically connected to a mains power supply; they are thus easier to install. A user can easily replace or recharge the blind battery or batteries as required.

According to a second aspect of the invention, there is provided a window blind comprising a roller tube, an idle end assembly and a window blind control apparatus as defined anywhere hereinabove, wherein the rotatable end of the motor is engaged with a control end of the roller tube. When the roller tube is engaged with the rotatable end of the motor, for example via roller tube engagement elements carried by the rotatable end of the motor, the roller tube is rotationally fixed to the rotatable end of the motor, wherein rotation of the rotatable end of the motor causes a corresponding rotation of the roller tube.

By the term “idle end”, it is meant an end of a roller blind which in use is rotatably coupled to a bracket and which is opposite to the control apparatus of the blind. The idle end typically includes an idle end bush adapted to engage one end of a roller tube and forms a bearing/axle arrangement with an idle end bracket which is adapted to allow the idle end of the roller tube to rotate relative to the idle end bracket. Examples of suitable idle end assemblies are defined and described in WO2010/139945, the contents of which are incorporated herein in their entirety by reference.

The roller tube may carry a blind substrate, for example a blind substrate may be wound around the roller tube, or it may carry lifting cords and/or control cords for a blind substrate in which embodiment, the lifting cords/control cords may be wound onto or unwound from the roller tube, for example to deploy or retract the blind substrate or vary its shading characteristics in some way.

The blind substrate may be in the form of a single sheet (which itself may be a laminate) or it may be in the form of a plurality of separate substrate elements, such as louvers or slats.

In an embodiment of the second aspect of the invention, the roller blind includes a headrail and the roller tube, idle end assembly and control apparatus are located within a channel at least partly defined by the headrail. The headrail may be secured to a suitable substrate, such as a wall or a ceiling. Thus, the channel may be defined by a combination of the headrail and one or more substrates. The headrail may define a longitudinally enclosed channel, for example it may have a body which is rectangular in cross section and which defines a channel therein. Alternatively, the headrail may include a longitudinal opening, for example, the headrail may comprise a body which is substantially C-shaped or U-shaped. In a further alternative embodiment, the headrail may include effectively two longitudinal openings, for example, the headrail may be substantially L-shaped. In such an embodiment, the headrail may be located adjacent to a suitable substrate (such as a wall or ceiling) which effectively closes an opening, in which case, the headrail and the substrate together define the channel.

In embodiments in which the motor is battery-powered and the blind includes a headrail, the headrail may include one or more battery support clips adapted to releasably secure one or more batteries to the headrail. The clips may include an anchor portion adapted for engagement with the headrail and a battery engagement portion which is releasably coupled to a battery in use. The battery engagement portion may comprise a C-shaped member having curved opposed arms that are resiliently deformable and which defines a receiving portion within which a battery is located in use.

The roller blind may further include a control end mounting bracket and an idle end mounting bracket, wherein one of the control end mounting bracket and the stationary member includes one or more locking apertures; the other of the control end mounting bracket and the stationary member includes one or more locking lugs; and in use the locking lugs engage respective locking apertures to prevent rotation of the stationary member relative to the control end mounting bracket. In this embodiment, the control end mounting bracket prevents rotation of the stationary member, which in turn prevents rotation of the stationary end of the motor.

The mounting brackets may be fixed to a suitable substrate, such as a wall or a ceiling, or they may be secured to a headrail which is secured to the suitable substrate.

Blind components are typically sold by the manufacturers to blind installers, who then take the components to build and install the blinds for the end user. Thus, according to a third aspect of the invention, there is provided a kit of parts for assembling a blind control apparatus, the kit including an electrical motor having a stationary end and a rotatable end; a stationary member which forms part of, or is adapted to be secured to, the stationary end of the motor; and an operating switch coupled to a conduit, wherein the opposite end of the conduit to the operating switch includes one part of a coupling and the stationary member includes a second part of the coupling, and wherein the conduit defines therein a channel which is open at each end and which is configured to receive therein electrical wires which in use connect the switch to the motor.

The kit may further include an idle end assembly, a control end mounting bracket, an idle end mounting bracket and/or a headrail. These components are all as defined and described hereinabove.

The skilled person will appreciate that the features described and defined in connection with the aspect of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

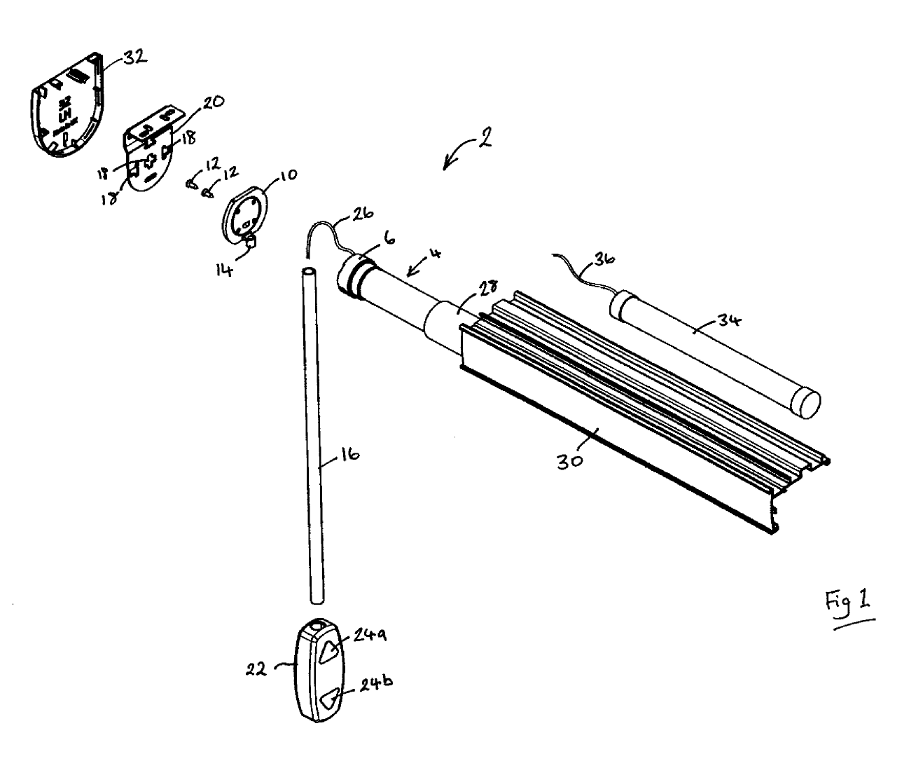

FIG. 1 is an exploded perspective view of a window blind control apparatus according to the first aspect of the invention;

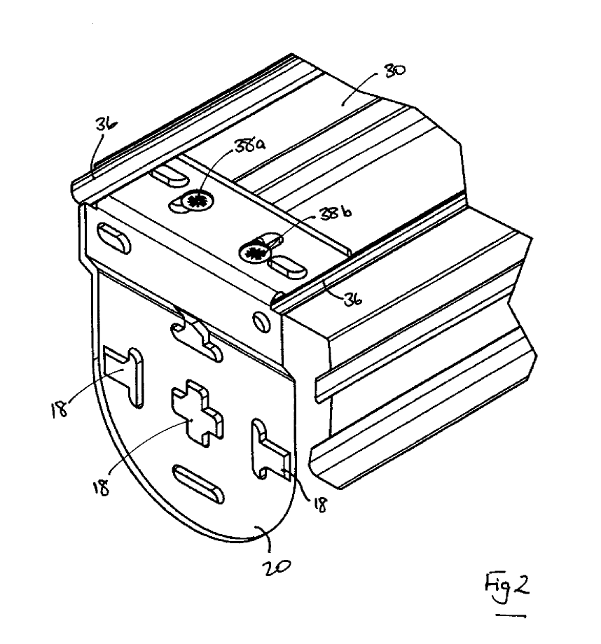

FIG. 2 is a perspective view showing the mounting of a control end mounting bracket to one end of a headrail;

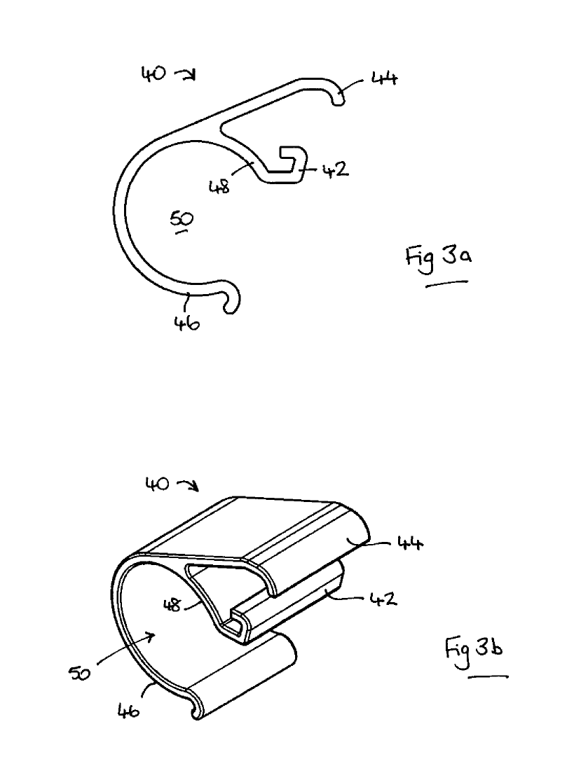

FIGS. 3a and 3b are respectively a side elevational view and a perspective view of a battery support clip; and

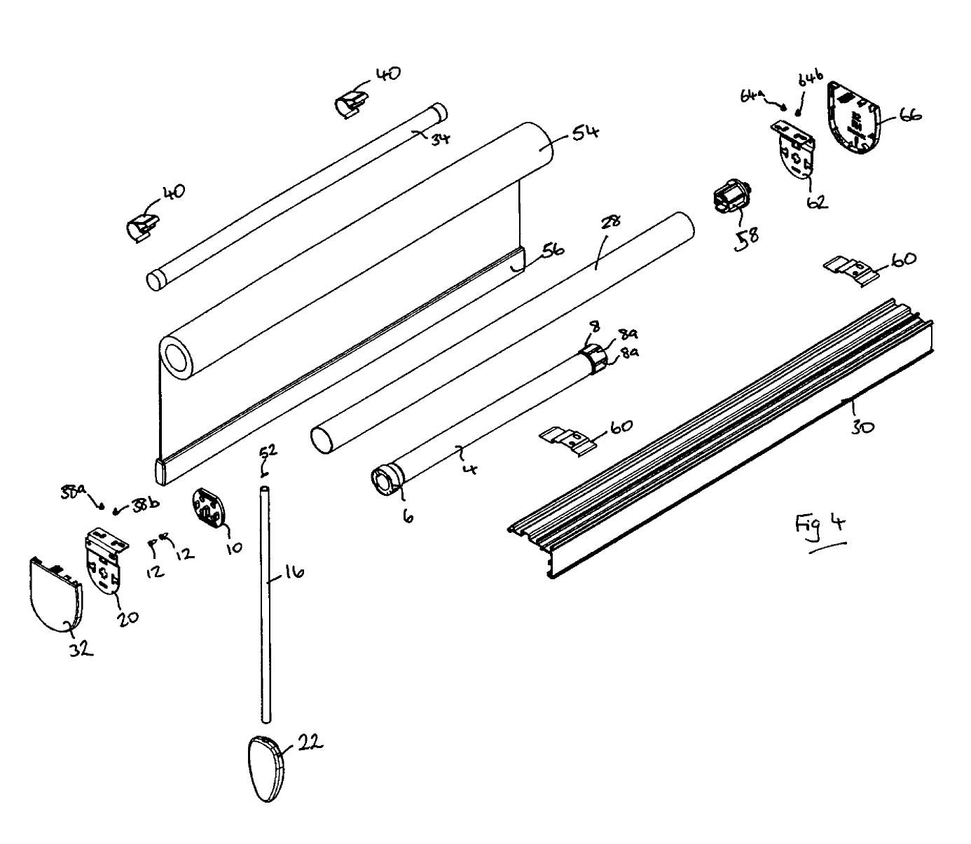

FIG. 4 is an exploded perspective view of a roller blind according to the second aspect of the invention.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows a window blind control apparatus indicated generally by the reference numeral 2. The control apparatus 2 includes a battery-powered motor 4 having a stationary end 6 and a rotatable end 8 (shown in FIG. 4). Secured to the stationary end 6 of the motor 4 is a motor end plate 10 which forms the stationary member of the present invention. The stationary member 10 is secured to the stationary end 6 of the motor 4 by a pair of screws 12.

At a lower end portion of the motor end plate 10 is defined a conduit support 14 having a substantially cylindrical body which is open at both ends. A conduit 16, formed from an elongate hollow polymeric body, is secured to the conduit support 14 by inserting the cylindrical body of the conduit support 14 into the longitudinal bore of the conduit 16 and fixing the conduit 16 to the conduit support 14 by any suitable means, for example via an adhesive layer, a rivet, a screw, a pin or similar fixing (not shown).

The face of the motor end plate 10 which faces away from the motor 4 includes three outwardly projecting locking lugs (not shown). The three locking lugs are arranged to engage with corresponding locking apertures 18 defined by a control end mounting bracket 20.

At the distal end (i.e. the end of the conduit opposite to the conduit support) of the conduit 16 is located an operating switch 22. The operating switch 22 can be any suitable operating switch which includes operating buttons 24a, 24b which function in use to operate the motor 4, which in turn controls a roller tube of the blind.

In use, the control end mounting bracket 20 is fixed to a headrail (described below) and is maintained stationary. The stationary end 6 of the motor 4 is secured against rotation by the motor end plate 10, which is screwed to the stationary end 6 and which is prevented from rotation via the interengagement of the locking lugs with the locking apertures 18 defined by the mounting bracket 20.

Control wires 26 for the motor 4 pass through the open ends of the conduit support 14 and pass through the conduit 16 to the operating switch 22 where they are connected to the operating buttons 24a, 24b in the conventional way.

The conduit 16 is resiliently deformable such that a user can pull the operating switch 22 towards them to operate the motor 4 from a comfortable position. Upon release of the operating switch 22, the conduit 16 returns to its rest configuration.

Also shown in FIG. 1 is a roller tube 28 into which the rotatable end 8 of the motor 4 is located. Although not shown in FIG. 1, but shown in FIG. 4, the rotatable end 8 of the motor 4 includes roller tube engagement elements 8a which in use engage with corresponding inwardly extending projections (not shown) defined by the roller tube 28. The interengagement of the engagement elements 8a with the projections rotationally locks the roller tube 28 to the rotatable end 8 of the motor 4.

The roller tube and control apparatus are located within a headrail 30 which is secured to a suitable substrate (described below). A cover plate 32 is provided to close the open end of the headrail and to provide an aesthetically pleasing appearance.

The motor 4 is a battery-powered motor and a battery pack 34 is provided to power the motor 4 in use. The battery pack 34 is electrically connected to the motor via electrical wires 36. The battery pack 34 in this embodiment is a rechargeable battery pack and may be recharged in situ. However, it is also within the scope of the invention as defined herein to provide a disposable battery pack or a battery pack which is removed for recharging.

FIG. 2 shows in more detail how the control end mounting bracket 20 is secured to the headrail 30. It will be noted that upper side portions of the mounting bracket 20 locate within recesses defined by side portions 36 of the headrail and the mounting bracket 20 is fixed to the headrail via a pair of screws 38a, 38b.

FIGS. 3a and 3b show a battery support clip 40 which secures the battery pack 34 to the headrail 30. The battery support clip 40 includes an anchor portion comprising a pair of locking legs 42, 44 and a pair of opposed resiliently deformable arms 46, 48 which together define a C-shaped channel 50. The locking leg 42, engages with the recess defined by the rear side portion 36 of the headrail 30 and the locking leg 44 engages with a projecting portion on the upwardly facing surface of the headrail 30 in order to secure the support clip 40 to the headrail 30. The battery pack 34 snap-fits into the C-shaped channel 50 by urging it towards the rear of the clip 40. This forces apart the opposed arms 46, 48, and permits the battery pack 34 to be inserted into the channel 50. Once the battery pack 34 is located in the correct position, the opposed arms 46, 48 are allowed to snap back into position. The battery pack 34 can be removed from the channel 50 simply by urging it away from the back of the clip 40. This reverses the above installation process and allows the battery pack 34 to be removed from the clip 40.

FIG. 4 shows an exploded view of a roller blind according to the second aspect of the invention, but without the electrical wires shown for clarity.

To assemble the blind shown in FIG. 4, the motor end plate 10 is screwed to the stationary end 6 of the motor via screws 12. The conduit 16 is then secured to the conduit support 14 via insertion of the conduit support into the longitudinal bore of the conduit 16 and fixing the two components together via a pin 52. The electrical wires 26 (not shown in FIG. 4) are passed through the bore of the hollow conduit 16 and electrically connected to the buttons 24a, 24b of the operating switch 22. The operating switch 22 is then secured to the distal end of the conduit 16 by any suitable means.

The rotatable end 8 of the motor 4 is then inserted into the roller tube 28 such that the roller tube engagement elements 8a engage with the corresponding inwardly projecting elements of the roller tube 28, thereby rotationally locking the roller tube to the rotatable end 8 of the motor 4.

The roller tube 28 has wound onto it a blind substrate 54 which includes a weighted bottom bar 56 secured to its lower edge portion.

An idle end assembly 58 in accordance with the specific embodiment described in WO2010/139945 is then inserted into the opposite end of the roller tube 28.

The foregoing forms a motorised roller tube sub-assembly.

The headrail 30 is secured to a part of a ceiling, which is adjacent to a window to be covered by the blind in use, via a pair of sprung mounting clips 60. The sprung mounting clips 60 are screwed to the ceiling and the headrail snap fits into the clips 60 in accordance with conventional blind systems which employ a headrail.

The control end mounting bracket 20 is then screwed to one end of the headrail 30 (the left hand end as shown in FIG. 4) via screws 38a, 38b, and an idle end mounting bracket 62 is screwed to the opposite end of the headrail 30 via screws 64a, 64b. The motorised roller tube sub-assembly is then installed between the opposed mounting brackets 20, 62 with the locking lugs of the motor end plate 10 engaged in the locking apertures 18 of the control end mounting bracket 20 and the cruciform end pin of the idle end assembly 58 engaged in the correspondingly shaped aperture defined by the idle end mounting bracket 62.

The battery pack 34 is secured to the headrail 30 via a pair of support clips 40 and electrically connected to the motor 4 as described above, and the blind is finished by the application of the control end cover plate 32 and an idle end cover plate 66.

1. A window blind control apparatus including an electrically operated motor having a stationary end and a rotatable end; a stationary member which forms a part of the stationary end of the motor or which is secured to the stationary end of the motor; an operating switch; and a conduit, wherein one end of the conduit carries the operating switch, the opposite end of the conduit is coupled to the stationary member and electrical wires which electrically connect the operating switch to the motor are located in use within the conduit.

2. A window blind control apparatus according to claim 1, wherein the conduit is fixed to the stationary member.

3. A window blind control apparatus according to claim 1, wherein the window blind is a roller blind and the rotatable end of the motor includes one or more roller tube engagement elements adapted to engage a roller tube

4. A window blind control apparatus according to claim 3, wherein the apparatus includes a roller tube rotationally fixed to the rotatable end of the motor.

5. A window blind control apparatus according to claim 1, wherein the conduit is a hollow tube.

6. A window blind control apparatus according to claim 1, wherein the conduit is formed from a metal or a polymeric material.

7. A window blind control apparatus according to claim 1, wherein the conduit is resiliently deformable.

8. A window blind control apparatus according to claim 1, wherein the conduit is hingedly coupled to the stationary member.

9. A window blind control apparatus according to claim 8, wherein the conduit is coupled to the stationary member via a universal joint.

10. A window blind control apparatus according to claim 1, wherein the motor is battery-powered and the apparatus further includes one or more batteries electrically connected to the motor.

11. A window blind control apparatus according to claim 10, wherein the or each battery is rechargeable.

12. A window blind comprising a roller tube, an idle end assembly and a window blind control apparatus includes an electrically operated motor having a stationary end and a rotatable end; a stationary member which forms a part of the stationary end of the motor or which is secured to the stationary end of the motor; an operating switch; and a conduit, wherein one end of the conduit carries the operating switch, the opposite end of the conduit is coupled to the stationary member and electrical wires which electrically connect the operating switch to the motor are located in use within the conduit; and wherein the rotatable end of the motor is engaged with a control end of the roller tube.

13. A window blind according to claim 12, wherein the blind further includes a headrail and the roller tube, idle end assembly and control apparatus are located within a channel at least partly defined by the headrail.

14. A window blind according to claim 13, wherein the motor is battery-powered and the blind further includes one or more batteries releasably secured to the headrail via one or more battery support clips.

15. A window blind according to claim 12, wherein the blind further includes a control end mounting bracket and an idle end mounting bracket, wherein the control end mounting bracket includes one or more locking apertures; the stationary member includes one or more locking lugs and in use the locking lugs engage respective locking apertures to prevent rotation of the stationary member relative to the mounting bracket.

16-17. (canceled)
